(19) United States
(12) Patent Application Publication
(10) Pub. No.: US 2017/0342350 A1
(43) Pub. Date: Nov. 30, 2017

(54) Detergent Composition Comprising A Bleach Catalyst And A Protease

(71) Applicant: THE PROCTER & GAMBLE COMPANY, CINCINNATI, OH (US)

(72) Inventors: NEIL JOSEPH LANT, NEWCASTLE UPON TYNE (GB); STEFANO SCIALLA, STROMBEEK-BEVER (BE); LINSEY SARAH FULLER, NEWCASTLE UPON TYNE (GB); ROBBY RENILDE FRANCOIS KEULEERS, LIPPELO (SINT AMANDS) (BE); ALAN THOMAS BROOKER, NEWCASTLE UPON TYNE (GB)

(21) Appl. No.: 15/596,344

(22) Filed: May 16, 2017

(30) Foreign Application Priority Data
May 26, 2016 (EP) 16171592.5

(51) Int. Cl. C11D 3/386; C11D 3/39; C11D 3/06; C11D 3/395

(52) U.S. Cl. CPC C11D 3/386; C11D 3/395; C11D 3/3945; C11D 3/06; C11D 3/3905; C11D 3/3917

(57) ABSTRACT

A detergent composition including an acyl hydrazone bleach catalyst and a protease having at least a 70% sequence identity to SEQ ID NO:1.

### FIELD OF THE INVENTION

The present disclosure relates to water-soluble unit dose articles comprising a protease and bleach catalyst and methods of their use.

### BACKGROUND OF THE INVENTION

Consumers desire to be more environmental friendly. Therefore, there is a tendency for consumers to select to wash fabrics and the like at lower temperatures. Lower temperature washing is less energy intensive and less energy is needed to heat up the water etc.

Detergent compositions tend to comprise both proteases and bleach ingredients to prove stain removal benefits across a broad range of stains. However, there is a tendency for the bleach ingredients to denature the enzymes during storage which can negatively affect the cleaning performance upon use.

Furthermore, at such lower temperatures there is a tendency for traditional detergent compositions to be less effective at removing some or all stains.

Therefore there is a need for a detergent composition that provides excellent stain removal benefits across a range of stains at lower temperatures and in which denaturation of the protease during storage is minimised.

It was surprisingly found that a detergent composition comprising an acyl hydrazone and a specific protease overcame this technical problem.

### SUMMARY OF THE INVENTION

The present disclosure relates to a detergent composition comprising an acyl hydrazone bleach catalyst and a protease having at least a 70% sequence identity to SEQ ID NO:1.

The present disclosure also relates to a water-soluble unit dose article comprising a detergent composition according to the present invention.

The present disclosure also relates to a process of washing fabrics comprising the steps of diluting the detergent composition according to the present invention in water by a factor of between 300 and 800 fold to create a wash liquor and contacting fabrics to be washed with said wash liquor.

The present disclosure also relates to a use of a detergent composition comprising an acyl hydrazone bleach catalyst and a protease having at least a 70% sequence identity to SEQ ID NO:1 to provide excellent stain removal across a range of stains at lower temperatures.

### DETAILED DESCRIPTION OF THE INVENTION

### Detergent Composition

The detergent composition comprises an acyl hydrazone bleach catalyst and a protease having at least a 70% sequence identity to SEQ ID NO:1. The acyl hydrazone bleach catalyst and the protease are described in more detail below.

The detergent composition may be in the form of free flowing powder, a liquid, a compacted solid, a gel or a mixture thereof, preferably wherein the detergent composition is in the form of a free flowing powder. Such a free flowing powder may have an average particle size diameter of between 100 microns and 1500 microns, preferably between 100 microns and 1000 microns, more preferably between 100 microns and 750 microns. Those skilled in the art will be aware of standard techniques to measure particle size.

The detergent composition may be a laundry detergent composition, an automatic dishwashing composition, a hand dish washing composition, a hard surface cleaner or a mixture thereof, preferably the detergent composition is a laundry detergent composition. By ‘laundry detergent’ we herein mean a composition that provides cleaning and/or care benefits to fabrics.

The detergent composition may comprise a source of hydrogen peroxide, wherein the hydrogen peroxide source is preferably selected from alkali metal perborates, alkali metal percarbonates, urea perhydrates, peroxycarboxylic acids, alkali metal persulfates, alkali metal peroxydisulfates, Caroates, diacyl peroxides, tetraacyl diperoxides or a mixture thereof.

Preferably the detergent composition comprises between 5% and 30%, more preferably between 6% and 25%, most preferably between 7% and 20% by weight of the detergent composition of the hydrogen peroxide source.

The detergent composition may comprise and adjunct ingredient, wherein the adjunct ingredient is preferably selected from TAED, soap, brightener, carboxymethylcellulose, enzymes, soil release polymer, surfactant, citrate, HEDP, 8-hydroxyquinoline sulphonic acid, dihydroxyterephthalic acid derivatives, alkali metal carbonates, alkali metal bicarbonates, alkali metal silicates, alkali metal sulphates or a mixture thereof.

The present invention also contemplates the use of a detergent composition according to the present invention comprising an acyl hydrazone bleach catalyst and a protease having at least a 70% sequence identity to SEQ ID NO:1 to provide excellent stain removal across a range of stains at lower temperatures.

### The Protease

The detergent composition comprises a protease having at least a 70% sequence identity to SEQ ID NO:1. The protease may have at least 71%, at least 72%, at least 73%, at least 74%, at least 75%, at least 76% at least 77% at least 78% at least 79% at least 80%, at least 81% at least 82% at least 83% at least 84% at least 85%, at least 86% at least 87% at least 88% at least 89%, at least 90%, at least 91%, at least 92%, at least 93%, at least 94%, at least 95% identity, at least 96%, at least 97%, at least 98%, or at least 99%, e.g. at least 99.1%, at least 99.2%, at least 99.3%, at least 99.4%, at least 99.5% or at least 99.6% sequence identity to SEQ ID NO: 1.

The detergent composition may comprise between 0.0001 and 0.2%, preferably between 0.0005% and 0.1%, more preferably between 0.001% and 0.05% by weight of the detergent composition of the protease. By weight percent of protease we herein mean weight percentage of the active enzyme protein.

The term “protease” is defined herein as an enzyme that hydrolyses peptide bonds. It includes any enzyme belonging to the EC 3.4 enzyme group (including each of the thirteen subclasses thereof). The EC number refers to Enzyme Nomenclature 1992 from NC-IUBMB, Academic Press, San Diego, Calif., including supplements 1-5 published in Eur. J. Biochem. 1994, 223, 1-5; Eur. J. Biochem. 1995, 232, 1-6; Eur. J. Biochem. 1996, 237, 1-5; Eur. J. Biochem. 1997, 250, 1-6; and Eur. J. Biochem. 1999, 264, 610-650; respectively. The term “subtilases” refer to a sub-group of serine protease according to Siezen et al., Protein Engng. 4 (1991) 719-737 and Siezen et al. Protein Science 6 (1997) 501-523. Serine proteases or serine peptidases is a subgroup of proteases characterised by having a serine in the active site, which forms a covalent adduct with the substrate. Further the subtilases (and the serine proteases) are characterised by having two active site amino acid residues apart from the serine, namely a histidine and an aspartic acid residue. The subtilases may be divided into 6 sub-divisions, i.e. the Subtilisin family, the Thermitase family, the Proteinase K family, the Lantibiotic peptidase family, the Kexin family and the Pyrolysin family. The term “protease activity” means a proteolytic activity (EC 3.4). Proteases of the invention are endopeptidases (EC 3.4.21.X). There are several protease activity types: The three main activity types are: trypsin-like where there is cleavage of amide substrates following Arg or Lys at P1, chymotrypsin-like where cleavage occurs following one of the hydrophobic amino acids at P1, and elastase-like with cleavage following an Ala at P1. For purposes of the present invention, protease activity is determined according to the procedure described in “Materials and Methods” below.

The term “parent” or protease parent means a protease to which an alteration is made to produce the enzyme variants of the present invention. Thus the parent is a protease having the identical amino acid sequence of said variant but not having the alterations at one or more of said specified positions. It will be understood, that in the present context the expression “having identical amino acid sequence” relates to 100% sequence identity.

The term “protease variant” means a protease having protease activity comprising an alteration, i.e., a substitution, insertion, and/or deletion, preferably substitution, at one or more (or one or several) positions compared to its parent which is a protease having the identical amino acid sequence of said variant but not having the alterations at one or more of said specified positions. A substitution means a replacement of an amino acid occupying a position with a different amino acid; a deletion means removal of an amino acid occupying a position; and an insertion means adding amino acids e.g. 1 to 10 amino acids, preferably 1-3 amino acids adjacent to an amino acid occupying a position.

The relatedness between two amino acid sequences or between two nucleotide sequences is described by the parameter “sequence identity”. For purposes of the present invention, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

The protease of the present invention has at least 70%, such as at least 71%, at least 72%, at least 73%, at least 74%, at least 75%, at least 76% at least 77% at least 78% at least 79% at least 80%, at least 81% at least 82% at least 83% at least 84% at least 85%, at least 86% at least 87% at least 88% at least 89%, at least 90%, at least 91%, at least 92%, at least 93%, at least 94% at least 95% identity, at least 96%, at least 97%, at least 98%, or at least 99%, e. g. at least 99.1%, at least 99.2%, at least 99.3%, at least 99.4%, at least 99.5% or at least 99.6% sequence identity to SEQ ID NO: 1.

Preferred proteases have substitutions of one or more amino acids in the loop corresponding to positions 171, 173, 175 or 179 of SEQ ID NO: 1, for example one or more of the following substitutions S171 {W, K, E, N}, S173 {P}, S175 {A, V, P} or G179 {C, V, Q, S, T, E, H, K, M, N, A, Y} of SEQ ID NO: 1, wherein the protease has a sequence identity to SEQ ID NO: 1 of at least 70% such as at least 71%, at least 72%, at least 73%, at least 74%, at least 75%, at least 76% at least 77% at least 78% at least 79% at least 80%, at least 81% at least 82% at least 83% at least 84% at least 85%, at least 86% at least 87% at least 88% at least 89%, at least 90%, at least 91%, at least 92%, at least 93%, at least 94% at least 95% identity, at least 96%, at least 97%, at least 98%, or at least 99%, e. g. at least 99.1%, at least 99.2%, at least 99.3%, at least 99.4%, at least 99.5% or at least 99.6 sequence identity to SEQ ID NO: 1.

Additionally, the protease described above may also contain a substitution at position F180Y.

Preferably, the protease has;
a) the amino acid at the position corresponding to position 171 of SEQ ID NO: 1 is selected from the group consisting of Trp, Lys, Glu, Asn and/or
b) the amino acid at the position corresponding to position 173 of SEQ ID NO: 1 is Pro, and/or
c) the amino acid at the position corresponding to position 175 of SEQ ID NO: 1 is Ala, Val, Pro, and/or
d) the amino acid at the position corresponding to position 179 of SEQ ID NO: 1 is selected from the group consisting of Cys, Val, Gin, Ser, Thr, Glu, His, Lys, Met, Asn, Tyr and Ala.

The protease may comprise an alteration at two positions corresponding to any of positions 171, 173, 175, 179, and 180.

The protease may comprise an amino acid at the position corresponding to position 180 of SEQ ID NO: 1 is Tyr.

The protease may comprise an amino acid at the position corresponding to position 175 of SEQ ID NO: 1 is Pro.

### Acyl Hydrazone Bleach Catalyst

The detergent composition comprises an acyl hydrazone bleach catalyst. Preferably, the detergent composition comprises between 0.001% and 1%, preferably between 0.01% and 0.75%, more preferably between 0.1% and 0.5% by weight of the composition of the acyl hydrazone bleach catalyst.

Preferably, the acyl hydrazone bleach catalyst has the formula I;

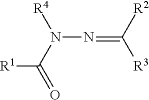

wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

More preferably, the acyl hydrazone bleach catalyst is 4-(2-(2-((2-hydroxyphenylmethyl)methylene)-hydrazinyl)-2-oxoethyl)-4-methylchloride having the formula II;

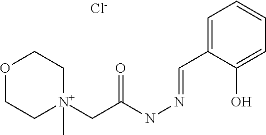 [SMILES: C[N+]1(CC(=O)N/N=C/c2ccccc2O)CCOCC1 ; [Cl-]]

Acyl hydrazone bleach catalysts boost the bleaching action of peroxidic bleaching agents, without unduly damaging the substrate to be cleaned, for example the fabric. The peroxidic bleaching agents are preferably H₂O₂ or substances that release H₂O₂ in water, including in particular alkali metal perborates, alkali metal percarbonates and urea perhydrates; however, they may be also possibly employed combined with peroxycarboxylic acids, such as diperoxydecanedicarboxylic acid or phthalimido peroxycaproic acid, with other acids or acidic salts, such as alkali metal persulfates or alkali metal peroxydisulfates or Caroates, or with diacyl peroxides or tetraacyl diperoxides.

Acyl hydrazones may be processed into the detergent in the form of a granulate. The granulate may be a two-layer coated granulate comprising;
a) a core pellet comprising 5 to 40% by weight based on the weight of the total granule of an acyl hydrazone of formula (I) and 1-10% by weight based on the weight of the total granule of water and/or water soluble binder which is selected from the group consisting of polyvinylalcohols, polyvinylpyrrolidones, polyacrylates, cellulose derivatives, carbohydrates, polyethyleneglycols and mixtures thereof;
b) 0.1% to 25% by weight based on the weight of the total granule of a subcoating comprising a polymer mixture of hydoxypropylmethylcellulose (HPMC) and methylcellulose (MC) in a ratio by weight of from 2:1 to 8:1;
c) 1 to 25% by weight based on the weight of the total granule of a topcoating comprising a fatty acid selected from nonadecanoic acid, stearic acid, palmitic acid, myristic acid and mixtures thereof; and
d) other components
   the sum of components (a) to (d) adding to 100%.

Preferably, the acyl hydrazone bleach catalyst is comprised within a granule, wherein preferably the granule comprises between 5% and 40% by weight of the granule of the acyl hydrazone bleach catalyst.

### Water-Soluble Unit Dose Article

One aspect of the present invention is a water-soluble unit dose article comprising a detergent composition according to any preceding claims. The water-soluble unit dose article comprises a water-soluble film. The water-soluble film is described in more detail below.

The water-soluble unit dose article comprises at least one water-soluble film shaped such that the unit-dose article comprises at least one internal compartment surrounded by the water-soluble film. The at least one compartment comprises the detergent composition. The water-soluble film is sealed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. The unit dose article is manufactured such that the water-soluble film completely surrounds the detergent composition and in doing so defines the compartment in which the detergent composition resides. The unit dose article may comprise two films. A first film may be shaped to comprise an open compartment into which the detergent composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

The first and second compartments maybe positioned side-by-side to one another, preferably wherein the first and second compartments are separated by a bridge region. The ‘bridge region’ is comprised of the film material and separates the two compartments from one another but allows the first compartment to stay attached to the second compartment and vice versa.

In a multi-compartment orientation, the first laundry cleaning or care composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

Preferably, the unit dose article comprises at least a first internal compartment and a second internal compartment and wherein the first compartment comprises the first composition and the second compartment preferably comprises a second composition wherein preferably the second composition is a liquid.

The water-soluble unit dose article may comprise at least a first compartment and a second compartment, wherein at least the first compartment comprises the detergent composition according to the present invention.

The water-soluble unit dose article may comprise at least a first compartment and a second compartment, wherein the detergent composition according to the present invention is comprised within the first and second compartments and wherein the first compartment comprises the acyl hydrazone bleach catalyst and the first compartment, second compartment or a mixture thereof comprises the protease.

Preferably, the water-soluble film comprises a polyvinylalcohol.

The film of the present invention is soluble or dispersible in water. The water-soluble film preferably has a thickness of from 20 to 150 micron, preferably 35 to 125 micron, even more preferably 50 to 110 micron.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or unit dose article, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films are those supplied by Monosol under the trade references M8630, M8900, M8779, M8310.

Of the total PVA resin content in the film described herein, the PVA resin can comprise 30 to 85 wt % of the first PVA polymer, or 45 to 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film. Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Process of Making

Those skilled in the art will be aware of standard methods and techniques to make the detergent composition.

Those skilled in the art will be aware of standard techniques to make the unit dose article. Standard forming processes including but not limited to thermoforming and vacuum forming techniques may be used.

### Process of Washing

One aspect of the present invention is a process of washing fabrics comprising the steps of diluting the detergent composition according to the present invention in water by a factor of between 300 and 800 fold to create a wash liquor and contacting fabrics to be washed with said wash liquor.

Preferably, the wash liquor is at a temperature of between 10° C. and 40° C., preferably between 12° C. and 35° C., more preferably between 15° C. and 30° C.

### Materials and Methods

### Protease Activity Assays:

1) Suc-AAPF-pNA Activity Assay:

The proteolytic activity can be determined by a method employing the Suc-AAPF-PNA substrate. Suc-AAPF-PNA is an abbreviation for N-Succinyl-Alanine-Alanine-Proline-Phenylalanine-p-Nitroanilide, and it is a blocked peptide which can be cleaved by endo-proteases. Following cleavage a free PNA molecule is liberated and it has a yellow colour and thus can be measured by visible spectrophotometry at wavelength 405 nm. The Suc-AAPF-PNA substrate is manufactured by Bachem (cat. no. L1400, dissolved in DMSO).

The protease sample to be analyzed was diluted in residual activity buffer (100 mM Tris pH 8.6). The assay was performed by transferring 60 μI of diluted enzyme samples to 96 well microtiter plate and adding 140 μI substrate working solution (0.72 mg/ml in 100 mM Tris pH8.6). The solution was mixed at room temperature and absorption is measured every 20 sec. over 5 minutes at OD 405 nm.

The slope (absorbance per minute) of the time dependent absorption-curve is directly proportional to the specific activity (activity per mg enzyme) of the protease in question under the given set of conditions. The protease sample should be diluted to a level where the slope is linear.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### Sequence

SEQ ID NO: 1 is submitted with this paper.

### Examples

A powder detergent composition is made comprising the following;

| | Wt % by weight of the |
|---|---|
| | laundry cleaning or |
| Ingredient | care composition |
| Percarbonate | 25%-35% |
| TAED | 7%-12% |
| 4-(2-(2-((2-hydroxyphenylmethyl)methylene)- | 0.001%-1% |
| hydrazinyl)-2-oxoethyl)-4-methylchloride | |
| protease having at least a 70% sequence | 0.0001%-0.2% |
| identity to SEQ ID NO: 1 | |
| Soap | 2%-5% |
| Brightener 49 | 0.01%-2% |
| Carboxymethylcellulose | 5%-12% |
| Sodium carbonate | 2%-6% |
| Sodium bicarbonate | 6%-14% |
| Sodium silicate | 6%-12% |
| Sulphate | 6%-12% |
| Water | 1%-4% |
| Enzymes, colourants, perfumes and other | Up to 100% |
| common laundry detergent ingredients | |

The above powder composition is formulated into a unit dose article comprising a water-soluble PVOH film, preferably M8630 film commercially available from Monosol.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising an acyl hydrazone bleach catalyst and a protease having at least a 70% sequence identity to SEQ ID NO:1.

2. The detergent composition according to claim 1 wherein the protease has at least 80% sequence identity to SEQ ID NO: 1.

3. The detergent composition according to claim 1 wherein the protease has at least 90% sequence identity to SEQ ID NO: 1.

4. The detergent composition according to claim 1 wherein the protease has at least 99% sequence identity to SEQ ID NO: 1.

5. The detergent composition according to claim 1 wherein;
(a) the amino acid at the position corresponding to position 171 of SEQ ID NO: 1 is selected from the group consisting of Trp, Lys, Glu, Asn and/or
(b) the amino acid at the position corresponding to position 173 of SEQ ID NO: 1 is Pro, and/or
c) the amino acid at the position corresponding to position 175 of SEQ ID NO: 1 is Ala, Val, Pro, and/or
d) the amino acid at the position corresponding to position 179 of SEQ ID NO: 1 is selected from the group consisting of Cys, Val, Gin, Ser, Thr, Glu, His, Lys, Met, Asn, Tyr and Ala.

6. The detergent composition according to claim 1 wherein the protease comprises an alteration at two positions corresponding to any of positions 171, 173, 175, 179, and 180.

7. The detergent composition according to claim 1 wherein the amino acid at the position corresponding to position 180 of SEQ ID NO: 1 is Tyr.

8. The detergent composition according to claim 1, wherein the amino acid at the position corresponding to position 175 of SEQ ID NO: 1 is Pro.

9. The detergent composition according to claim 1, wherein the acyl hydrazone bleach catalyst has the formula I: 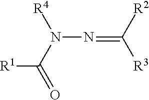
wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof;
preferably wherein the acyl hydrazone bleach catalyst is 4-(2-(2-((2-hydroxyphenylmethyl)methylene)-hydrazinyl)-2-oxoethyl)-4-methylchloride having the formula II;

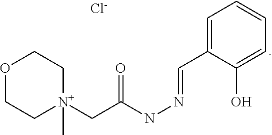 [SMILES: C[N+]1(CC(=O)N/N=C/c2ccccc2O)CCOCC1 ; [Cl-]]

10. The detergent composition according to claim 1, wherein the detergent composition is in the form of free flowing powder, a liquid, a compacted solid, a gel or a mixture thereof.

11. The detergent composition according to claim 1, wherein the detergent composition is a laundry detergent composition, an automatic dishwashing composition, a hand dish washing composition, a hard surface cleaner or a mixture thereof.

12. The detergent composition according to claim 1, wherein the detergent composition is a laundry detergent composition.

13. The detergent composition according to claim 1, comprising between 0.001% and 1%, by weight of the detergent composition, of the acyl hydrazone bleach catalyst.

14. The detergent composition according to claim 1, comprising between 0.0001% and 0.2%, by weight of the detergent composition, of the protease.

15. The detergent composition according to claim 1, further comprising a source of hydrogen peroxide.

16. The detergent composition according to claim 15, wherein the hydrogen peroxide source is selected from alkali metal perborates, alkali metal percarbonates, urea perhydrates, peroxycarboxylic acids, alkali metal persulfates, alkali metal peroxydisulfates, Caroates, diacyl peroxides, tetraacyl diperoxides or a mixture thereof.

17. The detergent composition according to claim 15, wherein preferably the detergent composition comprises between 5% and 30%, by weight of the detergent composition, of the hydrogen peroxide source.

18. A water-soluble unit dose article comprising a detergent composition according to claim 1.

19. A water-soluble unit dose article according to claim 18, wherein the water-soluble unit dose article comprises at least a first compartment and a second compartment,
wherein the detergent composition is comprised within the first and second compartments,
wherein the first compartment comprise the acyl hydrazone bleach catalyst, and
wherein the first compartment, second compartment or a mixture thereof comprises the protease.

20. A process of washing fabrics comprising the steps of diluting the detergent composition according to claim 1 in water by a factor of between 300 and 800 fold to create a wash liquor and contacting fabrics to be washed with said wash liquor.


SEQUENCE LISTING (1 sequence)

SEQ ID NO: 1 - protein, 311 aa, Bacillus sp. [sequence omitted]